(19) United States
(12) Patent Application Publication
(10) Pub. No.: US 2026/0005620 A1
(43) Pub. Date: Jan. 1, 2026

(54) PRE-CHARGE CIRCUIT AND BRAKING ENERGY MANAGEMENT FOR A POWER CONVERTER

(71) Applicant: Eaton Intelligent Power Limited, Dublin (IE)

(72) Inventors: Mahesh Mysore Swamy, Gurnee, IL (US); Hua Qiang Li, Menomonee Falls, WI (US)

(21) Appl. No.: 18/760,499

(22) Filed: Jul. 1, 2024

(51) Int. Cl. H02M 7/219; H02M 7/5387

(52) U.S. Cl. CPC H02M 7/219; H02M 7/5387

(57) ABSTRACT

A system includes: a direct current (DC) bus; a converter connected to the DC bus; a capacitive network electrically connected to the DC bus; and an energy management apparatus configured to pre-charge the capacitive network in a pre-charge mode and to dissipate energy from the DC bus in a braking mode. The energy management apparatus includes: a pre-charge circuit configured to pre-charge the capacitive network, the pre-charge circuit including: one or more pre-charge switches, each pre-charge switch being a controllable semiconductor switch; and a pre-charge impedance in parallel with the one or more pre-charge switches; and a braking resistance assembly electrically connected to the pre-charge circuit. The braking resistance assembly is configured to be electrically connected to the DC bus during the braking mode.

### TECHNICAL FIELD

This disclosure relates to pre-charge circuits and breaking energy management for a power converter.

### BACKGROUND

A power converter may be connected to an alternating current (AC) high-power electrical distribution system, such as a power grid. The power converter may drive, power, and/or control, for example, an electric machine or a power electronic load. The electrical apparatus includes an electrical network that converts AC power to direct-current (DC) power or DC power to AC power.

### SUMMARY

In one aspect, a system includes: a direct current (DC) bus; a converter connected to the DC bus; a capacitive network electrically connected to the DC bus; and an energy management apparatus configured to pre-charge the capacitive network in a pre-charge mode and to dissipate energy from the DC bus in a braking mode. The energy management apparatus includes: a pre-charge circuit configured to pre-charge the capacitive network, the pre-charge circuit including: one or more pre-charge switches, each pre-charge switch being a controllable semiconductor switch; and a pre-charge impedance in parallel with the one or more pre-charge switches; and a braking resistance assembly electrically connected to the pre-charge circuit. The braking resistance assembly is configured to be electrically connected to the DC bus during the braking mode.

Implementations may include one or more of the following features.

The converter may be an active front end.

The converter may be a diode front end.

The converter may include a plurality of semiconductor switches each including a body diode; each of the one or more pre-charge switches may include a body diode; and the pre-charge circuit is electrically connected to the capacitive network such that a polarity of the body diode of each of the one or more pre-charge switches is opposite a polarity of the body diode of at least some of the semiconductor switches of the converter. The pre-charge circuit may include a plurality of controllable semiconductor switches arranged into a plurality of phase legs, and each of the plurality of phase legs may include a first controllable switch and a second controllable switch; the braking resistance assembly may be electrically connected to the second controllable switch of each phase leg; in the pre-charge mode, the first controllable switch of each phase leg may be off such that current flows in the pre-charge impedance; and in the braking mode, the second controllable switch of each phase leg may be on such that the DC bus is electrically connected to the braking resistance assembly.

The braking resistance assembly may include at least one braking switch controllable to electrically connect a braking resistance to the DC bus during the braking mode. The at least one braking switch may be configured to be turned on and off during the braking mode.

In another general aspect, a system includes: a direct current (DC) bus including a first side and a second side; an active front end electrically connected to the DC bus, the active front end including a plurality of controllable semiconductor switches; a capacitive network electrically connected to the DC bus; and a pre-charge circuit configured to pre-charge the capacitive network, the pre-charge circuit including: one or more pre-charge switches, each pre-charge switch being a controllable semiconductor switch; and a pre-charge impedance.

Implementations may include one or more of the following features.

The one or more pre-charge switches may be inversely connected to at least some of the plurality of controllable semiconductor switches. The pre-charge impedance may include a first pre-charge impedance in parallel with a first pre-charge switch, a second pre-charge impedance in parallel with a second pre-charge switch, and a third pre-charge impedance in parallel with a third pre-charge switch. Each of the first pre-charge switch, the second pre-charge switch, and the third pre-charge switch may be a transistor; and each of the first pre-charge impedance, the second pre-charge impedance, and the third pre-charge impedance may be an inrush current limiter (ICL). The pre-charge circuit may include one pre-charge switch in series with the capacitive network, and the pre-charge impedance is in parallel with the one pre-charge switch. The pre-charge circuit may be in series with one of the first side of the DC bus and the second side of the DC bus. The one or more pre-charge switches may include a plurality of transistors arranged in a pre-charge electrical network, and the pre-charge electrical network may include: a first pre-charge phase leg, a second pre-charge phase leg, and a third pre-charge phase legs. Each of the first pre-charge phase leg, the second pre-charge phase leg, and the third pre-charge phase leg may include a first pre-charge transistor and a second pre-charge transistor. The pre-charge impedance may be in parallel with the first pre-charge transistor of the first pre-charge phase leg, the first pre-charge transistor of the second pre-charge phase leg, and the first pre-charge transistor of the third pre-charge phase leg. In some implementations, the system also includes a braking resistance apparatus in series with the second pre-charge transistor of each of the first phase leg, the second phase leg, and the third phase leg.

The system also may include a control system configured to: determine a status output based on electrical measurements; and determine whether to control the pre-charge circuit based on the status output.

The system also may include a braking resistance assembly in series with the pre-charge circuit.

In another aspect, an apparatus includes: a circuit including a controllable semiconductor switch and an impedance in parallel with the controllable semiconductor switch. The controllable semiconductor switch is associated with a parasitic diode having a first polarity, and the circuit is configured for electrical connection to a direct current (DC) bus of a converter with the first polarity being opposite a polarity of a parasitic diode of semiconductor switches of the converter.

The apparatus also may include a braking impedance apparatus electrically connected to the circuit.

Implementations of any of the techniques described herein may include an apparatus, a device, a system, a control system, machine-executable instructions, and/or a method. The details of one or more implementations are set forth in the accompanying drawings and the description below. Other features will be apparent from the description and drawings, and from the claims.

### DRAWING DESCRIPTION

FIG. 1 is a block diagram of an example of a power system.

FIG. 2A is a schematic of an example of a system that includes a power converter.

FIGS. 2B and 2C each show an example of a filter system.

FIG. 2D shows an example of a controllable semiconductor switch.

FIGS. 3-9 each show a schematic of another example of a system that includes a power converter.

FIG. 10 is a flow chart of an example of a process for operating a power converter in a protection mode.

### DETAILED DESCRIPTION

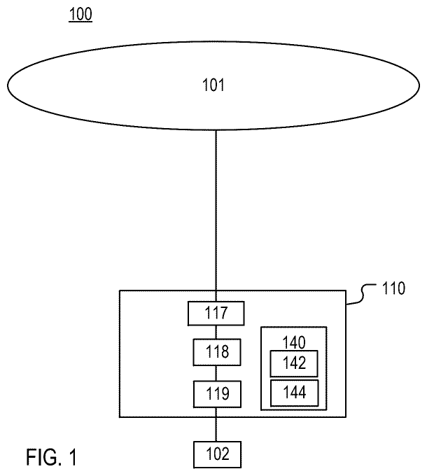

FIG. 1 is a block diagram of an example of a power system 100. The power system 100 includes a power converter 110 that is electrically connected to a source 101 and a load 102. The load 102 may be, for example, a motor, a lighting system, a machine, or a generator. The source 101 is any type of source of alternating current (AC) or time-varying electrical power. For example, the source 101 may be a node in an AC power grid or distribution network, an AC generator, or an output of an AC electrical apparatus, such as a transformer or voltage regulator.

The power converter 110 includes a rectifier 117, which converts AC electrical power into DC power that is stored in a DC link 118, and an inverter 119, which modulates the energy stored in the DC link 118 into AC energy that powers the load 102. The power converter 110 also includes a pre-charge circuit 140 that soft charges or pre-charges the DC link 118 prior to steady state operation of the power converter 110. The pre-charge circuit 140 includes a controllable semiconductor switch 142 and a pre-charge impedance 144. The controllable semiconductor switch 142 may be, for example, a transistor. The pre-charge impedance 144 may be, for example, an inrush current limiter (ICL) or a positive temperature coefficient (PTC) ICL.

Some legacy pre-charge circuits use one or more electromechanical contactors as a switching element. An electromagnetic contactor is a switch that includes an electromagnet and contacts. An electrical current passing through the contactor excites the electromagnet, producing a magnetic field, causing the contactor core to move a moveable contact and change the state of the contactor from open to closed or vice versa. On the other hand, the pre-charge circuit 140 lacks an electromechanical contactor and instead uses the semiconductor switch 142, which is smaller and more reliable than a contactor. Thus, the pre-charge circuit 140 provides space savings and improves mean time between failures (MTBF) while still effectively pre-charging the DC link 118.

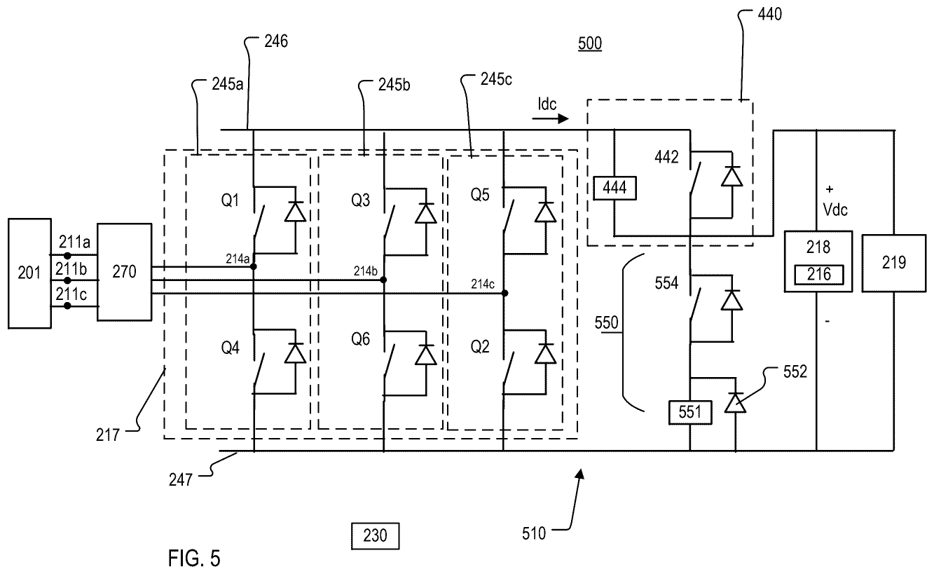

Furthermore, the pre-charge circuit 140 addresses challenges that can arise when pre-charging the DC link 118 in an implementation in which the rectifier 117 is an active front end (AFE). An AFE includes switches (for example, transistors) that can be controlled to convert AC power into DC power and DC power into AC power that may be returned to the source 101. Returned power is referred to as regenerative power or reverse power flow. In some implementations (such as shown in FIGS. 5-7), the pre-charge circuit 140 is electrically connected to a braking resistance assembly to allow the AFE to be used with a source that does not accept reverse power flow. The braking resistance assembly is a braking network made of switches, diodes, and/or resistors. In implementations that include a braking resistance assembly, the pre-charge circuit 140 is part of an energy management apparatus that includes the pre-charge circuit 140 and the braking resistance assembly. The energy management apparatus operates in a pre-charge mode to pre-charge the DC link 118 and in a braking mode to dissipate excess energy from the DC bus.

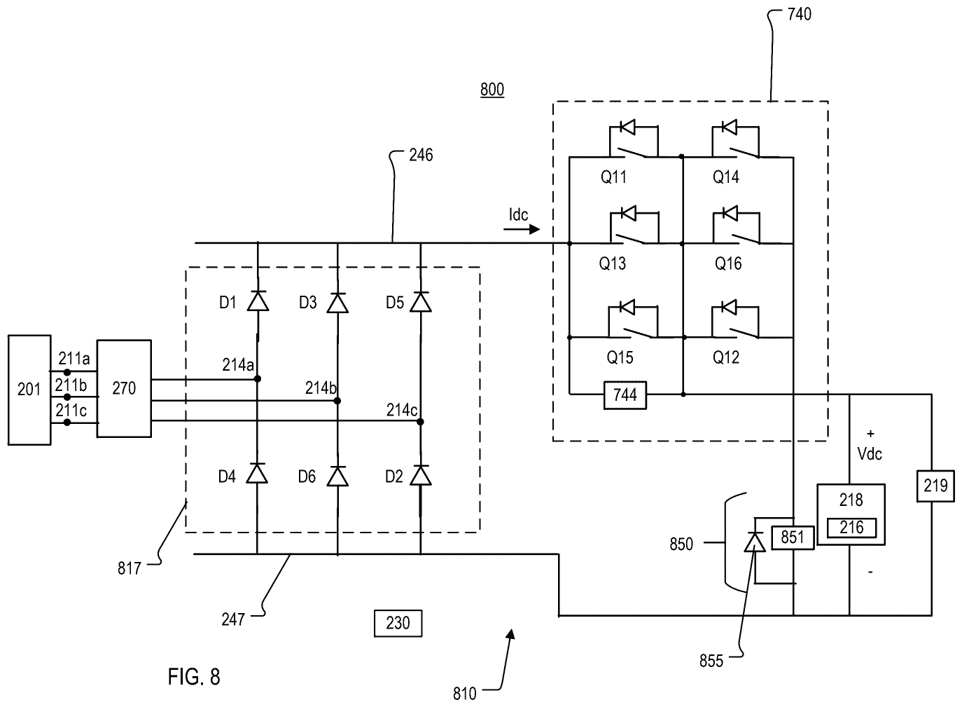

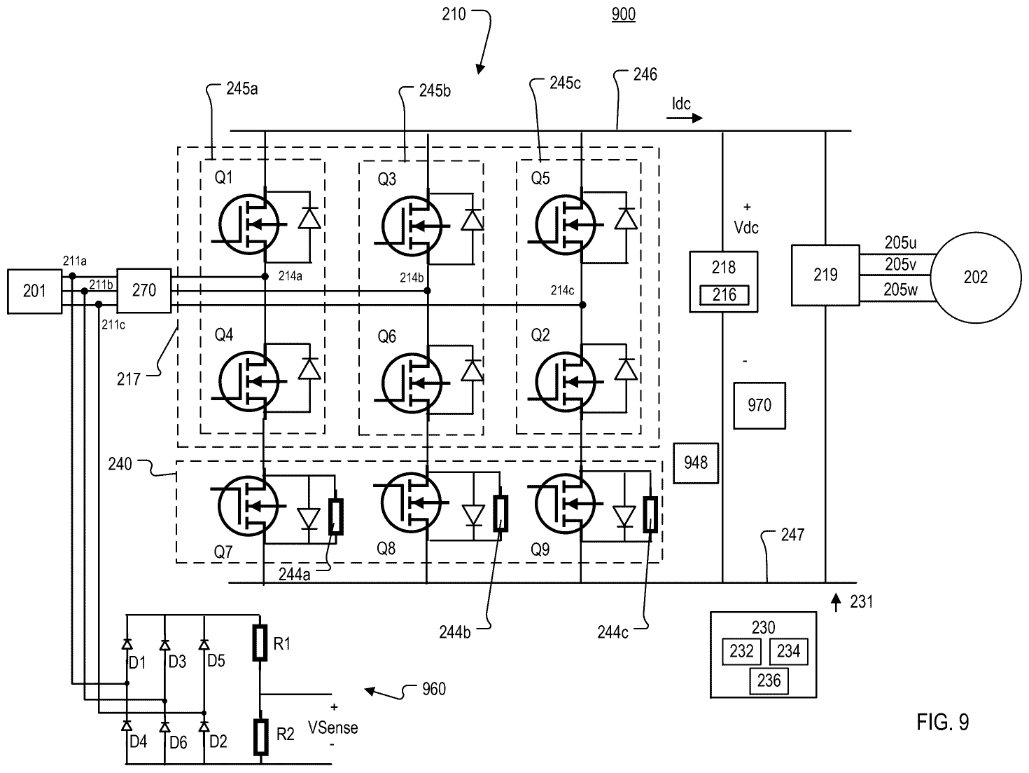

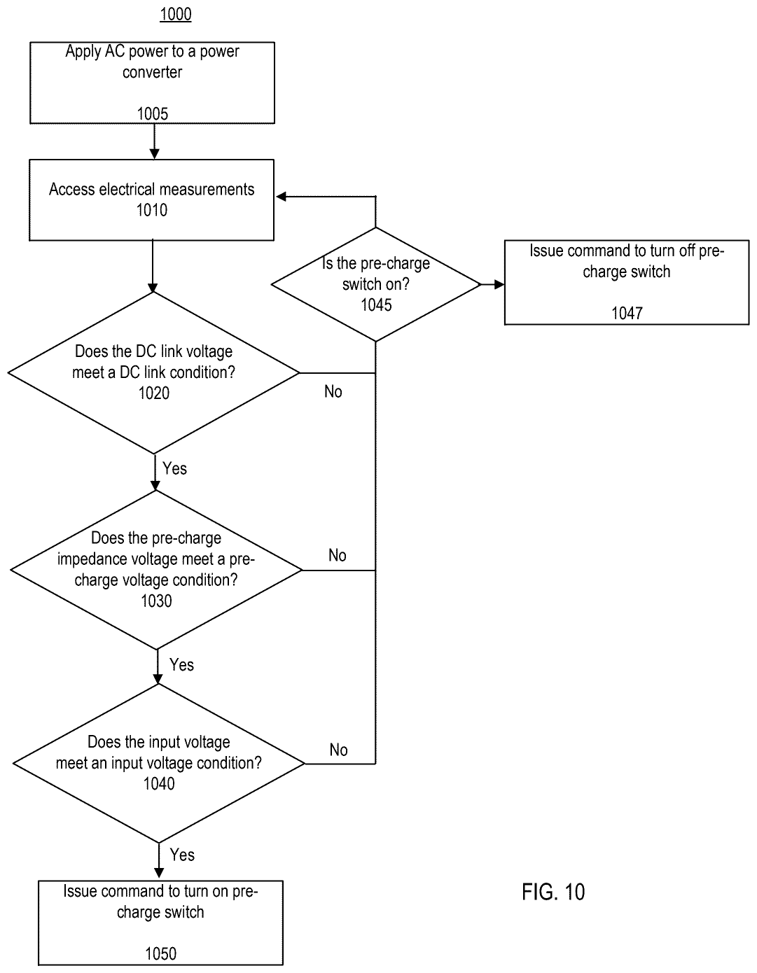

Moreover, although the pre-charge circuit 140 addresses challenges that may arise when pre-charging a DC link in a power converter that includes an AFE, the pre-charge circuit 140 may be used in implementations in which the rectifier 117 is not an AFE. For example, the pre-charge circuit 140 may be used with a diode rectifier or diode front end, as shown in FIG. 8. Additionally, the pre-charge circuit 140 provides protection during input phase faults and ground faults and allows brown-out and brown-in operation, as discussed with respect to FIGS. 9 and 10. Various implementations of the pre-charge circuit 140 are discussed below.

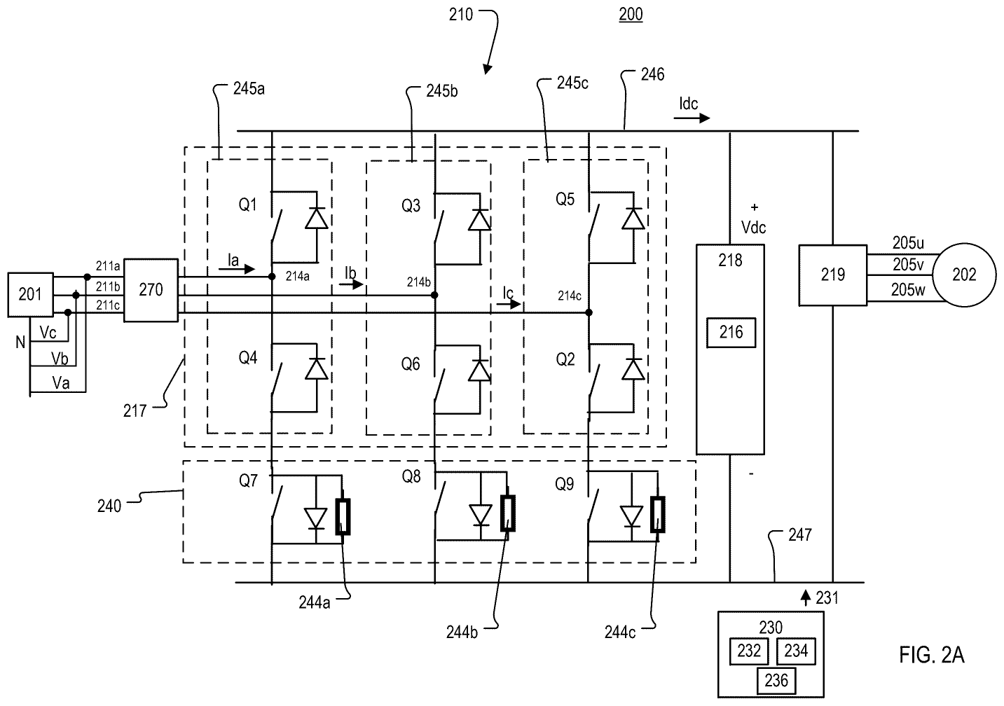

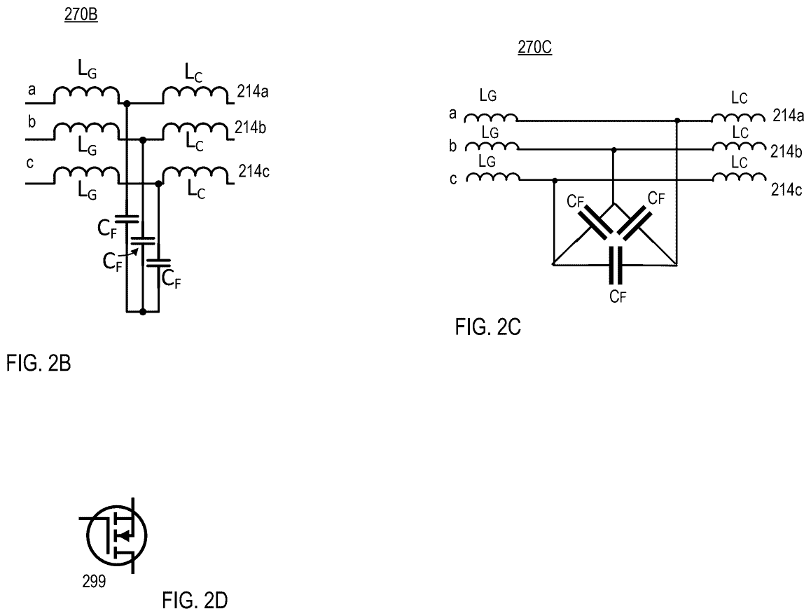

FIG. 2A is a schematic of a system 200 that includes a power converter 210. The dashed lines show groupings of components of the power converter 210 and do not necessarily represent physical objects or barriers.

The power converter 210 is connected to a three-phase load 202 and a three-phase source 201. The load 202 may be, for example, an induction motor or a permanent magnet synchronous machine. The source 201 is any source of AC power that includes three phases, which are referred to as a, b, and c and have respective phase voltages Va, Vb, Vc relative to the neutral (N) of the source 201. For example, the source 201 may be an electrical power distribution network that distributes AC electrical power that has a fundamental frequency of, for example, 50 or 60 Hertz (Hz) or a node in such a network.

The power converter 210 includes input nodes 211a, 211b, 211c, each of which is electrically coupled to one of the three phases (a, b, c) of the source 201. The power converter 210 also includes intermediate nodes 214a, 214b, 214c. The power converter 210 includes an active front end (AFE) 217, a DC link 218, and an inverter 219. The AFE 217 includes electronic switches Q1, Q2, Q3, Q4, Q5, Q6 that are controllable to convert AC currents ia, ib, ic at the nodes 214a, 214b, 214c into DC current Idc that flows to the DC link 218 via a DC bus. The switches Q1, Q2, Q3, Q4, Q5, Q6 are also controllable to convert energy stored in the DC link 218 into AC current that can flow into the source 201.

The AFE 217 includes three phase legs 245a, 245b, and 245c. The phase leg 245a includes the switches Q1 and Q4, the phase leg 245b includes the switches Q3 and Q6, and the phase leg 245c includes the switches Q5 and Q2. The switches Q1, Q3, Q5 may be referred to as the upper switches, and the switches Q4, Q6, Q2 may be referred to as the lower switches.

Referring also to FIG. 2D, each switch Q1, Q2, Q3, Q4, Q5, Q6 may be a metal-oxide-semiconductor field effect transistor (MOSFET) such as the transistor 299. However, other semiconductor switches may be used. For example, each switch Q1-Q6 may be an insulated gate bipolar transistor (IGBT). In some implementations, each electronic switch Q1, Q2, Q3, Q4, Q5, Q6 is made of a wide bandgap semiconductor material such as, for example, silicon carbide (SiC) or gallium nitride (GaN).

Each switch Q1, Q2, Q3, Q4, Q5, Q6 is associated with a body diode or parasitic diode having a polarity represented by a diode connected across the switch. In implementations in which each switch Q1 to Q6 is a MOSFETs, the node 214a is electrically connected to the source of the switch Q1 and the drain of the switch Q4, the node 214b is electrically connected to the source of the switch Q3 and the drain of the switch Q4, and the node 214c is electrically connected to the source of the switch Q5 and the drain of the switch Q2. The drain of each upper switch Q1, Q3, Q5 is connected to a high or positive side 246 of the DC bus. The source of each lower switch Q4, Q6, Q2 is connected to a pre-charge circuit 240.

The power converter 210 also includes a filter system 270. The filter system 270 is a low-pass filter that includes capacitive and/or inductive elements. FIGS. 2B and 2C show respective filter systems 270B and 270C, either of which may be used as the filter system 270. The filter system 270B is a three-phase filter. Each phase of the filter system 270B includes a grid-side inductor (L_{G}), a circuit-side inductor (Lc), and a filtering capacitor (Cf) that is electrically connected between the inductors Lgrid and Lc. The filter system 270C is similar but includes the filtering capacitors Cf in a delta configuration.

The filter systems 270B, 270C are provided as examples of configurations that may be used as the filter system 270. However, the filter system 270 may have other configurations. For example, the filter system 270 may be a three-phase filter that includes one inductor (instead of two) between each input node and respective intermediate node.

Referring again to FIG. 2A, the DC link 218 includes a capacitive network 216, which includes one or more devices that are capable of storing electrical energy. For example, the capacitive network 216 may include a capacitor or a network of capacitors connected in series and/or parallel. Rectified current Idc flows into the DC link 218 and charges the capacitor network 216, which stores energy in the form of voltage.

The inverter 219 modulates the energy stored in the DC link 218 into three-phase AC voltage and current and provides power to the load 202. The inverter 219 includes output terminals 205u, 205v, 205w, each of which is connected to one of the three phases of the load 202. The voltage that appears across the terminals 205u, 205v, 205w powers the load 202. The inverter 219 includes a network of electronic switches (for example, power transistors) that are controlled based on a control signal 231 to thereby control the voltage across the terminals 205u, 205v, 205w. The inverter 219 may be controlled based on a pulse width modulation (PWM) control scheme. In these implementations, the control signal 231 is a PWM control signal produced by the control system 230.

The power converter 210 also includes the pre-charge circuit 240. The pre-charge circuit 240 includes pre-charge semiconductor switches Q7, Q8, and Q9 and pre-charge impedances 244a, 244b, 244c. The pre-charge semiconductor switches Q7, Q8, and Q9 may be any type of controllable semiconductor switch, and each switch Q7, Q8, Q9 has a body diode or parasitic diode represented by the diode across the switch. For example, each switch Q7, Q8, Q9 may be a MOSFET with a body or parasitic diode represented by a diode connected across the source and drain. However, other types of transistors may be used and the switches Q7, Q8, Q9 may be a different type of switch than the AFE switches Q1 to Q6. Additionally, the switches Q7, Q8, Q9 may be three discrete devices or may be packaged together in a single module.

The switch Q7 is electrically connected to the AFE switch Q4 and the lower side 247 of the DC bus. The switches Q7 and Q4 are inversely connected such that the body diode of the switches Q7 and Q4 have inverse or opposite polarity. In other words when the switches Q4 and Q7 are off, current that flows in a particular direction can flow in the body diode of the switch Q4 or the body diode of the switch Q7 but cannot flow through both. The pre-charge switches Q8 and Q9 are inversely electrically connected to the respective AFE switches Q6 and Q2 and to the lower side 247 of the DC bus.

The pre-charge impedance 244a is in parallel with the pre-charge switch Q7, the pre-charge impedance 244b is in parallel with the pre-charge switch Q8, and the pre-charge impedance 244c is in parallel with the pre-charge switch Q9. Each pre-charge impedance 244a, 244b, 244c is any type of impedance and may be, for example, an inrush current limiter (ICL) or a PTC. Moreover, each pre-charge impedance 244a, 244b, 244c may have more than one impedance (for example, more than one ICL and/or more than one PTC) connected in series and/or in parallel with other impedance elements. The characteristics (for example, total impedance and topology) of the pre-charge impedances 244a, 244b, 244c can be tailored to the energy rating, desired charging rate, and/or capacitive energy of the capacitor network 216.

The power converter 210 is used with a control system 230. The control system 230 may be integrated into the power converter 210 or may be separate from and in communication with the power converter 210.

The control system 230 includes an electronic processing module 232, an electronic storage 234, and an input/output (I/O) interface 236. The control system 230 may be implemented as a microcontroller or a logic controller. The electronic processing module 232 includes one or more electronic processors. The electronic processors of the module 232 may be any type of electronic processor and may or may not include a general purpose central processing unit (CPU), a graphics processing unit (GPU), a microcontroller, a field-programmable gate array (FPGA), Complex Programmable Logic Device (CPLD), and/or an application-specific integrated circuit (ASIC).

The electronic storage 234 may be any type of electronic memory. In some implementations, the electronic memory is capable of storing instructions in the form of computer programs or software. The electronic storage 234 may include volatile and/or non-volatile components. The electronic storage 234 and the processing module 232 are coupled such that the processing module 232 is able to access or read data from and write data to the electronic storage 234. The electronic storage 234 stores instructions that, when executed, cause the electronic processing module 232 to analyze data and/or retrieve information. For example, the electronic storage 234 stores instructions that specify a control scheme, such as a PWM control scheme, to control the state of the switches Q1-Q6 and the switches of the inverter 219 during steady state operation of the power converter 210. The electronic storage 234 also stores instructions to control the pre-charge circuit 240.

The electronic storage 243 also stores threshold values or specifications that are used in operation of the power converter 210. For example, the electronic storage 234 may store a threshold value for Vdc that, when exceeded, indicates that a pre-charge period is complete. The electronic storage 234 also may store threshold values related to regenerative conditions.

The power converter 210 may include other elements that are not shown in FIG. 2A. For example, the power converter 210 may include sensors (for example, voltage and/or current sensors) that measure various electrical properties in the power converter 210. For example, the power converter 210 may include a voltage sensor that measures the voltage across the DC link 218 and/or the DC bus (Vdc) and provides an indication of the voltage to the control system 230. Moreover, the power converter 210 may include or may be used with sensors that directly or indirectly measure properties of the source 201 and/or the load 202. Other examples of elements in the power converter 210 include, without limitation, voltage sources and/or current sources that are controlled by the control system 230.

The operation of the pre-charge circuit 240 is discussed next. When the power converter 210 is initially powered on, the voltage (Vdc) across the DC link 218 is much less than the peak voltage at the input nodes 211a, 211b, 211c (collectively referred to as the input node 211) and the AFE switches Q1 to Q6 and the pre-charge switches Q7 to Q9 are off. The polarity of the parasitic diodes associated with the AFE switches Q1 to Q6 is such that the AFE switches Q1 to Q6 can conduct current when the switches Q1 to Q6 are off, but the parasitic diodes of the inversely connected pre-charge switches Q7 to Q9 prevent uncontrolled current flow into the capacitor network 216. Instead, current flows in the pre-charge impedances 244a, 244b, 244c, which provide smooth soft charging of the capacitor network 216.

The pre-charging of the capacitor network 216 is deemed completed when the voltage (Vdc) across the DC link 218 exceeds a threshold value. After the pre-charging of the capacitor network 216 is completed, the switches Q7, Q8, Q9 are turned on and remain on and the AFE 217 enters steady state operation. During steady state operation, the AFE switches Q1-Q6 are turned on and off according to a pulse width modulation (PWM) scheme or some other control pattern. However, the switches Q7, Q8, Q9 remain on, operating in a forward conduction mode and are not controlled based on a PWM control scheme or other control scheme. Because the switches Q7, Q8, Q9 remain on during the operation of the AFE 217, to reduce energy loss during operation of the AFE 217, MOSFETs or other transistors used for the switches Q7, Q8, Q9 may be selected based on having a low drain-source on resistance (Rdson).

The pre-charge circuit 240 does not include electro-mechanical contactors. Instead, the pre-charge circuit 240 includes the semiconductor switches Q7 to Q9. Using the semiconductor switches Q7 to Q9 instead of contactors reduces the size and cost of the pre-charge circuit. For example, some legacy power converters include a pre-charge apparatus that includes an electromechanical contactor in parallel with a resistor, with contactor placed in the DC bus with the DC link. With this arrangement, the current rating of the contactor is greater than the rated current operating point of the AFE, increasing the cost and size of the contactor. Furthermore, in this legacy arrangement, the contactor carries continuous DC current, which can be challenging to interrupt during fault conditions and can lead to early failure of the contactor.

Moreover, such a legacy design in a power converter that includes an AFE (such as the AFE 217) can cause challenges. For example, if a contactor was electrically connected to the high side 246 of the DC bus of the power converter 210, parasitic inductance in the contactor could create a high voltage differential (dv/dt) across the AFE switches Q1 to Q6 as they are undergoing the turn-off process during steady state operation of the AFE 217. The parasitic induction challenge may be worse when devices made of wide bandgap (WBG) semiconductors are used as the AFE switches Q1 to Q7. On the other hand, the pre-charge circuit 240 uses the pre-charge switches Q7, Q8, Q9 in the arrangement shown in FIG. 2A, and the pre-charge circuit 240 does not include a contactor at all. In this way, the pre-charge circuit 240 avoids or mitigates the challenges that may be presented by using a contactor as part of a pre-charge apparatus in a power converter that includes an AFE.

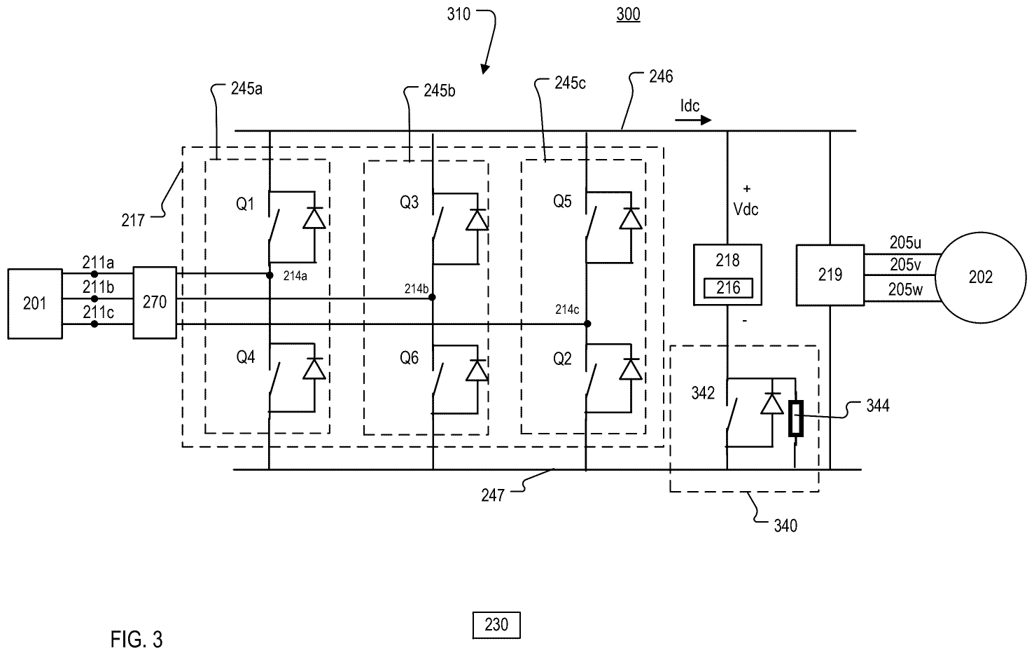

FIG. 3 is a schematic of a system that includes a power converter 310 connected to the the load 202 and the three-phase source 201. The power converter 310 is the same as the power converter 210 (FIG. 2A), except the power converter 310 includes a pre-charge circuit 340 instead of the pre-charge circuit 240. The pre-charge circuit 340 has fewer components than the pre-charge circuit 340. Like the pre-charge circuit 240, the pre-charge circuit 340 does not include any contactors.

The pre-charge circuit 340 includes a pre-charge semiconductor switch 342 in parallel with a pre-charge impedance 344. As shown in FIG. 2A, the pre-charge circuit 240 includes three semiconductor switches Q7, Q8, Q9 and respective parallel pre-charge impedances 244a, 244b, 244c. In comparison, the pre-charge circuit 340 has only one semiconductor switch (the switch 342) and one pre-charge impedance 344. Like the pre-charge circuit 240, the pre-charge circuit 340 is in series with the capacitor network 216. However, the pre-charge circuit 340 is connected to the lower side 247 of the DC bus. This positioning allows the pre-charge circuit 540 to include just one pre-charge switch 342 and just one pre-charge impedance 344. Due to having fewer components, the pre-charge circuit 340 may provide cost savings and may be easier to install.

Any semiconductor switch may be used as the pre-charge switch 342. For example, the pre-charge switch 342 may be a MOSFET with the source terminal connected to the lower side 247 of the DC bus and the drain terminal connected to the capacitor network 216. Other types of transistors may be used for the switch 342. For example, the switch 342 may be an IGBT.

The pre-charge switch 342 has a parasitic or body diode with a polarity as shown by the diode connected across the switch. The pre-charge switch 342 is connected between the capacitor network 216 and the lower side 247 of the DC bus such that the polarity of the body diode of the switch 342 is opposite to the body diode of each lower AFE switch Q4, Q6, Q2. The pre-charge impedance 344 is any type of impedance and may be, for example, an ICL or a PTC. The pre-charge impedance 344 may include more than one PTC.

The operation of the pre-charge circuit 340 is discussed next. When the power converter 310 is initially powered on, the voltage (Vdc) across the DC link 218 is much less than the peak voltage at the input node 211, and the AFE switches Q1 to Q6 and the pre-charge switch 342 are off. The polarity of the parasitic diodes associated with the AFE switches Q1 to Q6 is such that the AFE switches Q1 to Q6 can conduct current, but the parasitic diode of the inversely connected pre-charge switch 342 prevents uncontrolled current flow into the capacitor network 216. Specifically, due to the polarity of the parasitic diodes of the pre-charge switch 342, current initially flows in the pre-charge impedance 344 and not in the pre-charge switch 342. The capacitor network 216 is soft charged through the pre-charge impedance 344.

After the pre-charging of the capacitor network 216 is completed, the pre-charge switch 342 is turned on and remains on during steady-state operation of the AFE 217. During steady-state operation of the power converter 310, the current in the DC link 218 is bi-directional and generally only includes the reactive ripple current as demanded by the load 202. The AFE 217 side ripple current is minimal because the input power factor is generally close to or equal to 1. When the current is flowing through the pre-charge switch 342 in a direction to discharge the capacitor network 216, the pre-charge switch 342 operates as a synchronous rectifier because the pre-charge switch 342 is always on. To reduce energy loss during operation of the AFE 217, the pre-charge switch 342 may be selected based on having a low drain-source on resistance (Rdson). Because the pre-charge switch 342 is always on after the pre-charge is complete and the pre-charge switch 342 is not controlled based on PWM or another control scheme that relies on timed switching, the pre-charge switch 342 does not necessarily have a low switching loss.

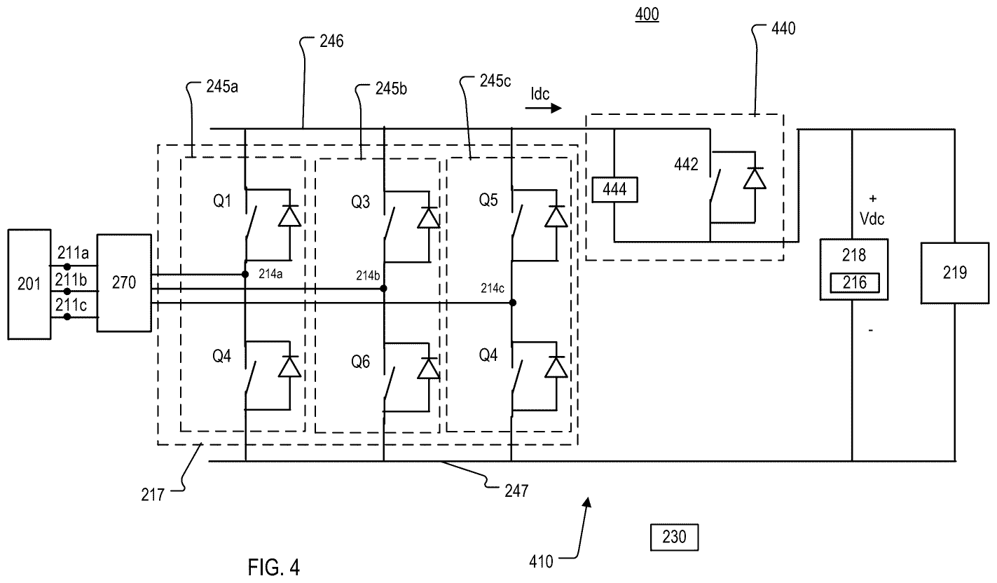

FIG. 4 is a schematic of a system 400 that includes a power converter 410 that includes a pre-charge circuit 440 electrically connected to the high side 246 of the DC bus between the AFE 217 and the DC link 218.

The pre-charge circuit 440 includes a pre-charge semiconductor switch 442 in parallel with a pre-charge resistance 444. Any semiconductor switch may be used as the pre-charge switch 442, and the switch 442 is not an electromagnetic contactor. For example, the pre-charge switch 442 may be a transistor. The pre-charge switch 442 may be in a discrete package. The pre-charge switch 442 includes a body diode or parasitic diode that is represented by a diode connected to the source and the drain of the pre-charge 442. The placement of the pre-charge switch 442 is such that the polarity of the body diode of the switch 442 is opposite to the polarity of the body diode of each of the AFE switches Q1 to Q6. The pre-charge impedance 444 is any type of impedance and may be, for example, an ICL or a PTC.

The operation of the pre-charge circuit 440 is discussed next. When the power converter 410 is initially powered on, the voltage (Vdc) across the DC link 218 is much less than the peak voltage at the input node 211, and the AFE switches Q1-Q6 and the pre-charge switch 442 are off. The polarity of the parasitic diodes associated with each AFE switch Q1-Q6 is such that the AFE switches Q1-Q6 conduct current, but the parasitic diode of the pre-charge switch 442 prevents current from flowing in the pre-charge switch 442 and prevents uncontrolled current flow into the DC link 218. Instead, current flows in the pre-charge impedance 444 such that the DC link 218 is soft-charged through the pre-charge impedance 444. After the voltage (Vdc) across the DC link exceeds a pre-determined threshold value, the pre-charging of the DC link 218 is complete, the pre-charge switch 442 is turned on, and the power converter 410 enters steady-state operation. The pre-charge switch 442 should be rated to handle the DC equivalent of the full load current, including overload condition.

Each of FIGS. 5, 6, and 7 show a respective power converter 510, 610, and 710 that includes the AFE 217 but may be used in applications in which the source 201 cannot accept reverse power flow. The AFE 217 can operate in all four quadrants. That is, when the load 202 produces regenerative energy and the voltage across the DC bus rises due to the regenerative energy, the AFE 217 can convert the excess DC voltage into AC voltage that can be returned to the source 201. However, if the source 201 is a diesel generator or other source that cannot accept reverse power flow, the excess voltage across the DC bus voltage can lead to a fault conditions in the power converter. To handle such conditions, the pre-charge circuit used in the main DC bus to pre-charge the DC link 218 is also equipped with a braking resistance assembly that dissipates the excess voltage on the DC bus.

FIG. 5 is a schematic of a system 500 that includes the power converter 510. The power converter 510 includes the AFE rectifier 217 and the pre-charge circuit 440. As shown, the pre-charge circuit 440 is in the high side 246 of the DC bus with the polarity of the body diode of the pre-charge switch 422 in opposition to the polarity of the body diode of each of the AFE switches Q1, Q3, Q5.

The power converter 510 also includes a braking resistance assembly 550 that is electrically connected to the pre-charge circuit 440. The braking resistance assembly 550 includes a controllable switch 554 in series with a braking resistance 551. The braking resistance 551 is in parallel with a diode 552. The diode 552 is used to handle circulating current that can arise due to inductance in the braking resistance 551 during switching operation. The switch 554 and the pre-charge switch 442 may be packaged together in a single module.

The controllable switch 554 has a body diode with a polarity represented by the diode connected across the switch 554. The switch 554 may be a transistor, such as a MOSFET or an IGBT. In implementations in which the switch 554 is a MOSFET, the drain of the switch 554 is electrically connected to the source of the pre-charge switch 422, and the source of the switch 554 is electrically connected to the parallel combination of the braking resistance 551 and the diode 552.

The operation of the pre-charge circuit 440 is as discussed with respect to FIG. 4. After the pre-charge of the DC link 218 is complete, the power converter 510 operates in steady state or typical operation and provides power to the load 202. The pre-charge switch 442 remains on during normal operation. The switch 554 is off and current does not flow into the braking resistance assembly 550 during normal operation.

In the implementation shown in FIG. 5, the source 201 cannot accept reverse power. Thus, when a regenerative condition exists, the regenerative power is dissipated via the braking resistance assembly 550. A regeneration condition occurs when regenerative power from the load 202 causes the voltage (Vdc) across the DC link 218 to increase. The presence of a regenerative condition may be identified, for example, by the voltage Vdc exceeding a threshold value, a negative torque feedback value sensed by the current sensors, an increase in speed of the motor beyond the commanded speed, or the relationship between voltage and current indicating reverse power flow.

In response to detecting a regenerative condition, the control system 230 turns the switch 554 on and off such that current on the DC bus flows through the switch 554 into the braking resistance 551, which dissipates the excess energy as heat. The switch 554 is turned on an off until the regenerative condition no longer exists. After the regenerative condition is over, the control system 230 turns off the switch 554 and the power converter 510 resumes steady state operation.

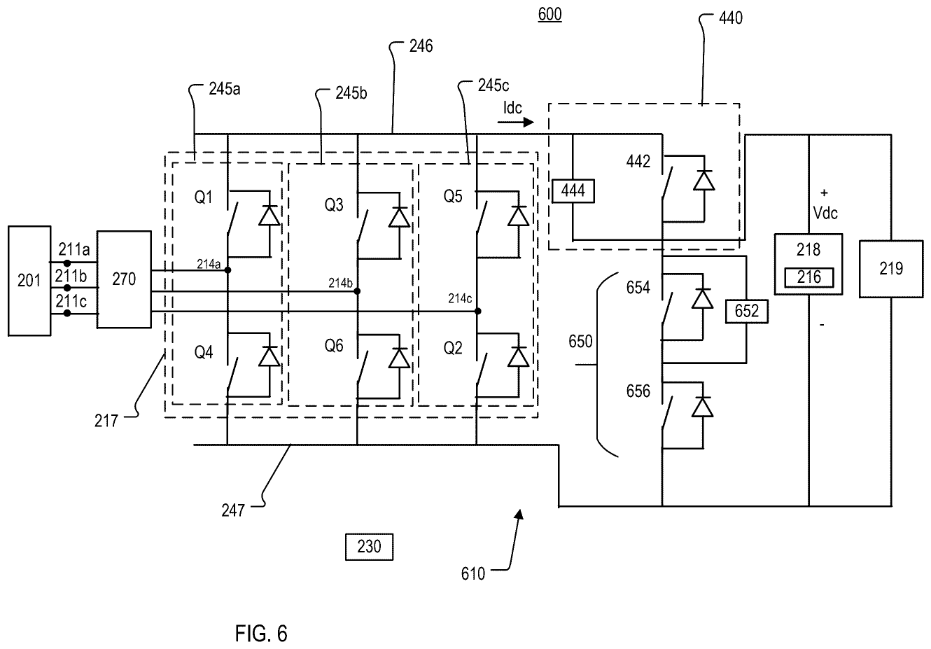

FIG. 6 is a schematic of system 600 that includes the power converter 610. The power converter 610 includes the AFE rectifier 217 and the pre-charge circuit 440. As shown, the pre-charge circuit 440 is in the high side 246 of the DC bus with the pre-charge switch 422 arranged such that the body diode of the switch 442 is in opposition to the polarity of the body diode of each of the AFE switches Q1, Q3, Q5.

The power converter 610 also includes a braking resistance assembly 650 that is electrically connected to the pre-charge circuit 440. The braking resistance assembly 650 includes controllable semiconductor switches 654 and 656 and a braking resistance 652 connected in parallel with the switch 654. The switches 654 and 656 may be transistors, for example, IGBTs or MOSFETs. The switches 654 and 656 may be in one module or package. The switch 654 is always in the OFF position. This allows the free-wheeling diode to be placed across the braking resistor 652. When regeneration is detected, the switch 654 is turned on an off (for example, based on PWM control) to dissipate the excess DC bus energy through the braking resistor 652. The diode across the switch 654 helps in circulating the current flowing through the braking resistance 652 when the switch 656 is turned OFF in PWM manner to allow for parasitic inductive current flow.

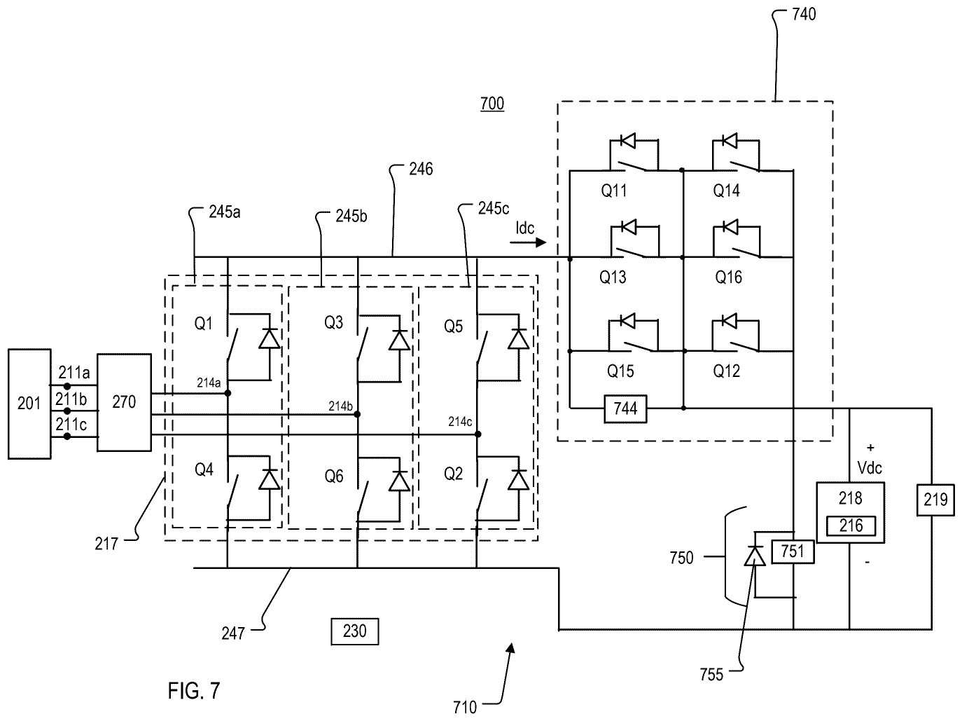

FIG. 7 is a schematic of a system 700 that includes the power converter 710. The power converter 710 includes the AFE 217 and a pre-charge module 740 in series with the high side 246 of the DC bus. The pre-charge module 740 is used to pre-charge the DC link 218. The pre-charge module 740 is also configured to dissipate regenerative energy in applications in which the source 201 cannot accept reverse power flow.

The pre-charge module 740 is similar to the AFE 217. In the example shown, each of the AFE 217 and the pre-charge module 740 is a 6-in-1 three-phase semiconductor switch module. The pre-charge module 740 includes controllable semiconductor switches Q11 to Q16. Each switch Q11 to Q16 may be, for example, a silicon (Si) MOSFET, an SiC MOSFET, or an IGBT. The switches Q11, Q13, and Q15 are the input side or upper half of the pre-charge module 740. The switches Q12, Q14, and Q16 are the output side or lower half of the pre-charge module 740. The switches Q11, Q13, and Q15 are in parallel with a pre-charge impedance 844. The parallel combination of the switches Q11, Q13, and Q15 act as a controllable semiconductor pre-charge switch. The combination of the switches Q11, Q13, and Q15 has three times the current rating of each phase leg 245a, 245b, 245c and can carry the DC current that flows in the DC bus.

The switches Q12, Q14, and Q16 in the lower half of the pre-charge module 740 are used to dissipate regenerative power from the load 202. The switches Q12, Q14, and Q16 are in parallel with each other and in series with a braking resistance assembly 750. The braking resistance assembly 850 includes a resistive element 751 (for example, an ICL) in parallel with a discrete diode 755 that handles circulating currents that may arise due to inductance in the resistive element 751. The braking resistance assembly 750 is electrically connected to the switches Q12, Q14, and Q16 and the low side 247 of the DC bus.

The operation of the pre-charge module 740 and the braking resistance assembly 750 are discussed next.

When the power converter 710 is initially powered on, the voltage (Vdc) across the DC link 218 is much less than the peak voltage at the input node 211, and the AFE switches Q1-Q6 are off. The pre-charge module switches Q11, Q13, Q15 in the upper half of the pre-charge module 740 are also off. The pre-charge module switches Q12, Q14, Q16 in the lower half of the pre-charge module 740 are also off. The polarity of the parasitic diodes associated with each AFE switch Q1-Q6 is such that the AFE switches Q1-Q6 conduct current, but the parasitic diodes of the switches in the pre-charge module 740 prevent uncontrolled current flow into the DC link 218. Instead, current flows in the pre-charge impedance 744 such that the DC link 218 is soft-charged through the pre-charge impedance 744. After the voltage across the DC link 218 exceeds a pre-determined threshold value, the pre-charge switches Q11, Q13, Q15 in the upper half of the pre-charge module 740 are turned on and the power converter 710 enters steady-state operation. During steady state operation, the pre-charge switches Q12, Q14, Q16 remain off and current does not flow into the braking resistance assembly 750.

In response to detecting a regeneration condition, the control system 230 turns on the pre-charge module switches Q12, Q14, Q16 such that the DC bus is connected to the braking resistance assembly 750, allowing regenerative power to be dissipated through the resistive element 751 of the braking resistance assembly 750.

FIG. 8 is a schematic of a system that includes a power converter 810. The power converter 810 is the same as the power converter 810 except the power converter 810 includes a diode rectifier 817 instead of the AFE 217. The diode rectifier 817 includes diodes D1 to D6. The diode rectifier 817 rectifies AC current from the source 201 into the DC current Idc but cannot convert DC power into AC power. Accordingly, the power converter 810 does not return power to the source 201.

When the power converter 810 is initially powered on, the voltage (Vdc) across the DC link 218 is much less than the peak voltage at the input node 211. The pre-charge module switches Q11, Q13, Q15 in the upper half of the pre-charge module 740 are off. The polarity of the diodes D1 to D6 is such that current can flow in the rectifier 817, but the parasitic diodes of the pre-charge module 740 (which are opposite the polarity of the diodes D1 to D6) prevent uncontrolled current flow into the DC link 218. Instead, current flows in the pre-charge impedance 744 such that the DC link 218 is soft-charged through the pre-charge impedance 744. After the voltage across the DC link exceeds a pre-determined threshold value, the upper pre-charge switches Q11, Q13, Q15 are turned on and the power converter 810 enters steady-state operation. During steady state operation of the power converter 810, the lower pre-charge switches Q12, Q14, Q16 remain off such that current does not flow into the braking resistance assembly 850.

In response to detecting a regeneration condition, the control system 230 turns on the lower pre-charge module switches Q12, Q14, Q16 such that regenerative power is dissipated through the resistive element 851 of the braking resistance assembly 850.

FIGS. 9 and 10 relate to brown-in and brown-out operation. FIG. 9 is a schematic of a system 900, which shows the power converter 210 (FIG. 2A) used with a DC voltage sensing system 970, an input sensing system 960, and a pre-charge sensing system 948. FIG. 10 is a flow chart of a process 1000 for operating a power converter in a protection mode.

The DC voltage sensing system 1070 produces an indication of the DC voltage across the capacitor network 216 (Vdc). The DC voltage sensing system 970 may be a voltage sensor that is connected to the high side 246 and the low side 247 of the DC bus. The input sensing system 960 produces an indication of the AC input voltage (Vsense). The input sensing system 960 includes diodes D1 to D6 arranged as a three-phase rectifier. The diodes D1 to D6 rectify the AC current at the nodes 211a, 211b, 211c into a rectified DC current that flows into a voltage divider formed by resistors R1 and R2. The input sensing system 960 measures a voltage (Vsense) across the resistor R1 or R2, which provides an indication of the AC voltage at the nodes 211a, 211b, 211c. Additionally, the rectified DC voltage reduces when there is a single-phase input fault or a ground fault. Thus, the indication of the voltage (Vsense) across the resistor R1 or R2 also allows input fault monitoring.

The pre-charge sensing system 948 produces an indication of the voltage across the pre-charge impedances 244a, 244b, and/or 244c. For example, the pre-charge sensing system 948 may include a resistive voltage divider that is connected to each pre-charge switch Q7, Q8, Q9 through a diode. In this implementation, the voltage across one of the resistors in the voltage divider (Vicl) provides an indication of the voltage across the pre-charge impedances 244a, 244b, 244c.

The DC sensing system 970, the input sensing system 960, and the pre-charge sensing system 948 may include any type of sensor capable of producing an indication of voltage or an indication of a measurement from which voltage can be determined. Such sensors include, without limitation, voltage sensors and/or current sensors (for example, hall-effect sensors, current transformers, and/or Rogowski coils). The sensing system 970, the input sensing system 960, and the pre-charge sensing system 948 provide the indications 931 of measured data to the control system 230.

The sensing system 970 and the input sensing system 960 may be used with any of the power converters 110, 310, 410, 510, 610, 710, and 810 in the configuration shown in FIG. 9. The pre-charge sensing system 948 may be used with any of the power converters 110, 310, 410, 510, 610, 710, and 810 with variations in configuration and connection as appropriate to measure the voltage across the pre-charge impedance used in the various pre-charge circuits and pre-charge modules discussed above. For example, when used with a power converter that includes the pre-charge circuit 440 (FIG. 4), the pre-charge sensing system 940 may be a voltage sensor that is placed across the pre-charge impedance 444. However, regardless of the specific configuration of the pre-charge sensing system 948, the system 948 produces an indication of a voltage across a pre-charge impedance.

FIG. 10 is the flow chart of the process 1000. The process 1000 is implemented by the control system 230. The process 1000 is discussed with respect to the system 900 to provide an example. However, the process 1000 may be used with any of the power converters 110, 310, 410, 510, 610, 710, 810. The process 1000 may be used instead of the pre-charge operations discussed above with respect to these various power converters.

The process 1000 is initiated when AC power is applied to the power converter 210 (1005). The electrical measurements 931 are accessed (1010). The electrical measurements 931 include an indication of a voltage across the capacitor network 216 (Vdc), an indication of the voltage across the pre-charge impedances 244a, 244b, 244c (V_{ICL}), and an indication of the AC input voltage (V_{SENSE}). These indicators are referred to as the indicators Vdc, V_{ICL}, V_{SENSE}.

Each indicator Vdc, V_{ICL}, V_{SENSE} is analyzed relative to a specification, reference value, or condition that is associated with that indicator to determine a status for each indicator. The status is positive or high (shown as “Yes” in FIG. 10) if the condition is met. The status is negative or low (shown as “No” in FIG. 10) if the condition is not met. The status may be a binary value with 1 representing a positive (or high) status and 0 representing a negative (or low) status.

The specifications or conditions are pre-determined and are stored on the electronic storage 234 of the control system 230. Each specification or condition may be a threshold value that specifies a minimum or maximum voltage value, or a range of voltage values that are associated with acceptable performance. In the example of FIG. 10, the electronic storage 234 stores three conditions: a DC link condition, a pre-charge voltage condition, and an input voltage condition.

When power is applied to the power converter 210 at (1005), the pre-charge switches Q7, Q8, Q9 and the AFE switches Q1 to Q6 are OFF. The polarity of the parasitic diodes of the AFE switches Q1 to Q6 can conduct current but the inverse mounted pre-charge switches Q7, Q8, Q9 prevent uncontrolled current flow into the capacitor network 216. Current does not flow in the pre-charge switches Q7, Q8, Q9 and instead flows into the pre-charge impedances 244a, 244b, 244c and into the capacitor network 216. The current that flows through the pre-charge impedances 244a, 244b, 244c pre-charges the capacitor network 216 and the voltage (Vdc) across the DC link 218 begins to increase.

The control system 230 analyzes the electrical measurements 931 to determine whether to turn on the pre-charge switches Q7, Q8, Q9 as follows. The indicator of the voltage (Vdc) across the DC link 218 is compared to a DC link condition (1020). The DC link condition is a pre-defined voltage value. The DC link condition may be, for example, a voltage value that is known to be associated with an under-voltage condition. If the measured or calculated voltage (Vdc) across the DC link 218 is greater than the DC link condition, the DC link condition is met and the status of the voltage (Vdc) indicator is positive, and the process 1000 advances to (1030). If the measured or calculated voltage (Vdc) is less than or equal to the DC link condition, the DC link condition is not met and the status of the voltage (Vdc) indicator is negative.

The indicator of the voltage (V_{ICL}) across the pre-charge impedances 244a, 244b, 244c is compared to a pre-charge voltage condition (1030). The pre-charge voltage condition is a voltage value. If the measured or calculated voltage (V_{ICL}) is less than the pre-charge voltage condition, the pre-charge voltage condition is met and the status of the voltage (V_{ICL}) indicator is positive. Otherwise, the pre-charge voltage condition is not met and the status of the indicator (V_{ICL}) is negative.

The indicator of the input voltage (V_{SENSE}) is compared to the input voltage condition (1040). The input voltage condition is a voltage value. If the input voltage (V_{SENSE}) is greater than the input voltage condition, the input voltage condition is met and the status of the input voltage (V_{SENSE}) indicator is positive. Otherwise, the input voltage condition is not met and the status of the input voltage (V_{SENSE}) is negative.

If the status of any indicator is negative, the process 1000 returns to (1010) and continues to monitor the electrical measurements 931. If the status of all of the indicators is positive, all of the conditions have been met, and the control system 230 issues a command to cause the pre-charge switches 242a, 242b, 242c to turn on (1050). For example, the control system 230 may control a voltage source such that the voltage at each pre-charge switch 242a, 242b, 242c is sufficient to turn on each pre-charge switch 242a, 242b, 242c. When the pre-charge switches 242a, 242b, 242c are on, current flows in the AFE switches Q1 to Q6, in the pre-charge switches Q7 to Q9, and into the DC link 218. Current does not flow in the pre-charge impedances 244a, 244b, 244c because each pre-charge impedance 244a, 244b, 244c has an impedance that is greater than the impedance of the respective pre-charge switch 242a, 242b, 242c in its on state. For example, the drain-source on resistance (Rsdon) of the pre-charge switch 242a is less than the impedance of the pre-charge impedance 244a. The voltage (Vdc) across the capacitor network 216 reaches its maximum value, the pre-charge process is complete, and the power converter 210 operates in steady state.

The process 1000 returns to (1010) and the pre-charge switches 242a, 242b, 242c remain on with the power converter 210 operating in steady state. The control system 230 continues to monitor the electrical measurements 931 and to check the conditions at (1020), (1040), (1050).

This continued monitoring during steady state operation of the power converter 210 allows the control system 230 to react to brown-out conditions effectively. A brown-out condition occurs when the peak voltage provided by the source 201 drops below the voltage across the DC link 218. During a brown-out condition, the voltage across the DC link 218 also drops. However, because the time constant of the capacitor network 216 are relatively large, the voltage across the DC link 218 changes much more slowly than the input voltage. Monitoring only the voltage across the DC link 218 may delay the detection of a brown-out condition such that the pre-charge path through the pre-charge impedances 244a, 244b, 244c is not available for current flow before the brown-out condition ends. In this situation, when the brown-out condition ends, there is a voltage difference between the nodes 211a, 211b, 211c and the DC link 218. This difference may cause inrush currents to flow into the capacitor network 216 because, as long as the pre-charge switches 242a, 242b, 242c are on, current flows in the impedance pre-charge switches 242a, 242b, 242c and not in the pre-charge impedances 244a, 244b, 244c. Thus, delayed detection of a brown-out condition may lead to uncontrolled and/or high inrush currents.

However, in the process 1000, if the status of any indicator V_{SENSE}, Vdc, V_{ICL} does not meet its respective condition while the pre-charge switches 242a, 242b, 242c are on (1045), the pre-charge switches 242a, 242b, 242c are turned off (1047). For example, if the input voltage (V_{SENSE}) falls below the input voltage condition value, the status of the indicator V_{SENSE} is negative, and the control system 230 causes the pre-charge switches 242a, 242b, 242c to turn off. The input voltage falling below the input voltage condition value is a sign that a brown-out condition has begun. The time constant of the filtering capacitor Cf is much less than the time constant of the DC link capacitor network 216. Thus, the voltage across the sensing resistor R2 in the sensing system 960 changes more quickly after the brown-out condition begins than the voltage (Vdc) across the DC link 218. In another example, a brown-out condition may cause the polarity of the voltage across the pre-charge impedances 244a, 244b, 244c to reverse such that the pre-charge impedance voltage indicator (V_{ICL}) no longer meets the pre-charge impedance condition. The control system 230 causes the pre-charge switches 242a, 242b, 242c to turn off when the pre-charge impedance voltage indicator (V_{ICL}) does not meet the pre-charge impedance condition during steady state operation of the power converter 210.

Because the input voltage (V_{SENSE}) indicator (as measured indirectly at the resistor R1 or as measured directly) and the pre-charge impedance voltage (V_{ICL}) indicator change and react to the drop in input voltage of brown-out condition more quickly than the voltage across the DC link 218, monitoring all of the indicators (V_{SENSE}), (Vdc), (V_{ICL}) allows the control system 230 to more quickly detect and respond to a brown-out condition than a legacy system that only uses a measurement of the voltage across the DC link 218.

After the pre-charge switches 242a, 242b, 242c are off, current begins to flow in the pre-charge impedances 244a, 244b, 244c instead of through the pre-charge switches 242a, 242b, 242c. As a result, when the input voltage (V_{SENSE}) recovers from the brown-out condition and has a peak voltage that is greater than the voltage across the DC link 218, current flows in the pre-charge switches 242a, 242b, 242c and uncontrolled and/or large inrush currents that would otherwise occur are avoided or minimized. In this way, the control system 330 handles brown-out and brown-in conditions effectively and quickly.

The control system 230 turns the pre-charge switches 242a, 242b, 242c on when the input voltage (V_{SENSE}) is greater than the DC link voltage value, the voltage (V_{ICL}) across the pre-charge impedance is less than the pre-charge voltage impedance condition value, and the voltage (Vdc) across the DC link 218 is greater than the DC link condition. After the pre-charge switches 242a, 242b, 242c are turned on, the power converter 210 resumes steady-state operation.

These and other implementations are within the scope of the claims.

What is claimed is:

1. A system comprising:
a direct current (DC) bus;
a converter connected to the DC bus;
a capacitive network electrically connected to the DC bus; and
an energy management apparatus configured to pre-charge the capacitive network in a pre-charge mode and to dissipate energy from the DC bus in a braking mode, the energy management apparatus comprising:
a pre-charge circuit configured to pre-charge the capacitive network, the pre-charge circuit comprising:
one or more pre-charge switches, each pre-charge switch being a controllable semiconductor switch; and
a pre-charge impedance in parallel with the one or more pre-charge switches; and
a braking resistance assembly electrically connected to the pre-charge circuit, wherein the braking resistance assembly is configured to be electrically connected to the DC bus during the braking mode.

2. The system of claim 1, wherein the converter is an active front end.

3. The system of claim 1, wherein the converter is a diode front end.

4. The system of claim 1, wherein the converter comprises a plurality of semiconductor switches each comprising a body diode; each of the one or more pre-charge switches comprises a body diode; and the pre-charge circuit is electrically connected to the capacitive network such that a polarity of the body diode of each of the one or more pre-charge switches is opposite a polarity of the body diode of at least some of the semiconductor switches of the converter.

5. The system of claim 4, wherein the pre-charge circuit comprises a plurality of controllable semiconductor switches arranged into a plurality of phase legs, and each of the plurality of phase legs comprises a first controllable switch and a second controllable switch;
the braking resistance assembly is electrically connected to the second controllable switch of each phase leg;
in the pre-charge mode, the first controllable switch of each phase leg is off such that current flows in the pre-charge impedance; and
in the braking mode, the second controllable switch of each phase leg is on such that the DC bus is electrically connected to the braking resistance assembly.

6. The system of claim 1, wherein the braking resistance assembly comprises at least one braking switch controllable to electrically connect a braking resistance to the DC bus during the braking mode.

7. The system of claim 6, wherein the at least one braking switch is configured to be turned on and off during the braking mode.

8. A system comprising:
a direct current (DC) bus comprising a first side and a second side;
an active front end electrically connected to the DC bus, the active front end comprising a plurality of controllable semiconductor switches;
a capacitive network electrically connected to the DC bus; and
a pre-charge circuit configured to pre-charge the capacitive network, the pre-charge circuit comprising:
one or more pre-charge switches, each pre-charge switch being a controllable semiconductor switch; and
a pre-charge impedance.

9. The system of claim 8, wherein the one or more pre-charge switches are inversely connected to at least some of the plurality of controllable semiconductor switches.

10. The system of claim 9, wherein the pre-charge impedance comprises a first pre-charge impedance in parallel with a first pre-charge switch, a second pre-charge impedance in parallel with a second pre-charge switch, and a third pre-charge impedance in parallel with a third pre-charge switch.

11. The system of claim 10, wherein each of the first pre-charge switch, the second pre-charge switch, and the third pre-charge switch is a transistor; and each of the first pre-charge impedance, the second pre-charge impedance, and the third pre-charge impedance is an inrush current limiter (ICL).

12. The system of claim 9, wherein the pre-charge circuit comprises one pre-charge switch in series with the capacitive network, and the pre-charge impedance is in parallel with the one pre-charge switch.

13. The system of claim 9, wherein the pre-charge circuit is in series with one of the first side of the DC bus and the second side of the DC bus.

14. The system of claim 9, wherein the one or more pre-charge switches comprises a plurality of transistors arranged in a pre-charge electrical network, the pre-charge electrical network comprising: a first pre-charge phase leg, a second pre-charge phase leg, and a third pre-charge phase legs, wherein each of the first pre-charge phase leg, the second pre-charge phase leg, and the third pre-charge phase leg comprises a first pre-charge transistor and a second pre-charge transistor.

15. The system of claim 14, wherein the pre-charge impedance is in parallel with the first pre-charge transistor of the first pre-charge phase leg, the first pre-charge transistor of the second pre-charge phase leg, and the first pre-charge transistor of the third pre-charge phase leg.

16. The system of claim 15, further comprising a braking resistance apparatus in series with the second pre-charge transistor of each of the first phase leg, the second phase leg, and the third phase leg.

17. The system of claim 9, further comprising a control system configured to:
determine a status output based on electrical measurements; and
determine whether to control the pre-charge circuit based on the status output.

18. The system of claim 1, further comprising a braking resistance assembly in series with the pre-charge circuit.

19. An apparatus comprising:
a circuit comprising a controllable semiconductor switch and an impedance in parallel with the controllable semiconductor switch, wherein the controllable semiconductor switch is associated with a parasitic diode having a first polarity, and the circuit is configured for electrical connection to a direct current (DC) bus of a converter, wherein the circuit is configured for electrical connection to the DC bus with the first polarity being opposite a polarity of a parasitic diode of semiconductor switches of the converter.

20. The apparatus of claim 19, further comprising a braking impedance apparatus electrically connected to the circuit.
